(19) United States
(12) Patent Application Publication
(10) Pub. No.: US 2010/0013942 A1
(43) Pub. Date: Jan. 21, 2010

(54) DIGITAL CAMERAS INDICATING SELECTED MODE

(76) Inventor: Arlene T. Jourdan, Rochester, NY (US)

Correspondence Address: Peter P. Hernandez;Patent Legal Staff, Eastman Kodak Company, 343 State Street, Rochester, NY, 14650-2201, US

(21) Appl. No.: 12/174,667

(22) Filed: Jul. 17, 2008

(51) Int. Cl. H04N 5/228

(52) U.S. Cl. 348/222.1; 348/E05.031

(57) ABSTRACT

An imaging device having first and second operable modes of operation, the imaging device includes a user interface for selecting the first operable mode of operation or a second operable mode of operation; a processor that, upon startup, detects whether the first operable mode of operation or the second operable mode of operation is selected; and one or more sensory mechanisms that output a first signal when the processor detects the first operable mode and outputs a second signal when the processor detects the second operable mode of operation.

### FIELD OF THE INVENTION

The present invention relates generally to image capture devices, such as digital cameras, and more particularly to such digital cameras having a mechanism for indicating, upon startup, which of two or more operable modes is currently selected for operation.

### BACKGROUND OF THE INVENTION

Most digital cameras include at least two normal modes of operation. For example, most digital cameras have a still mode for capturing still images and a video mode for capturing video images. While multiple modes of operation are beneficial to users, it is not uncommon for users of such digital cameras to accidentally have the camera in the wrong mode; for example, in video mode when they actually desired to have it in still mode.

Prior art traditional cameras, such as U.S. Pat. No. 4,999,662, have a feature which permits users to distinguish between an operable mode and a non-operable mode. In this prior art camera, an indication is given for informing the user whether the camera does not have film, a non-operable state; or has film, an operable state. Such features are generally classified as an “alarm” which indicates that the device is or is not ready for use.

While “alarms” are useful, they are ineffective to prevent a user from accidentally operating the device in a first operable state when actually a second operable state was desired. This may cause a user to miss capturing a scene in the mode desired by the user. For example, if a user wishes to capture a scene, which is only available for a short time period, for display in a frame (still mode) for an office and the camera is in video mode, the opportunity to capture the scene is lost.

Consequently, a need exists for a camera which prevents a user from missing opportunities to capture a scene in its intended form.

### SUMMARY OF THE INVENTION

It is therefore an object of the present invention to provide a digital camera having a mechanism for indicating which of several modes is selected for use by a user upon startup.

These and other objects, features, and advantages of the present invention will become apparent to those skilled in the art upon a reading of the following detailed description when taken in conjunction with the drawings wherein there is shown and described an illustrative embodiment of the invention.

### Advantages

The present invention provides the advantage of reducing the chance of missing capturing a scene that is only available for a short period of time by indicating the mode of operation which is currently selected for use.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram of a digital camera of the present invention; and

FIG. 2 is the back side of the digital camera of the present invention.

### DETAILED DESCRIPTION OF THE INVENTION

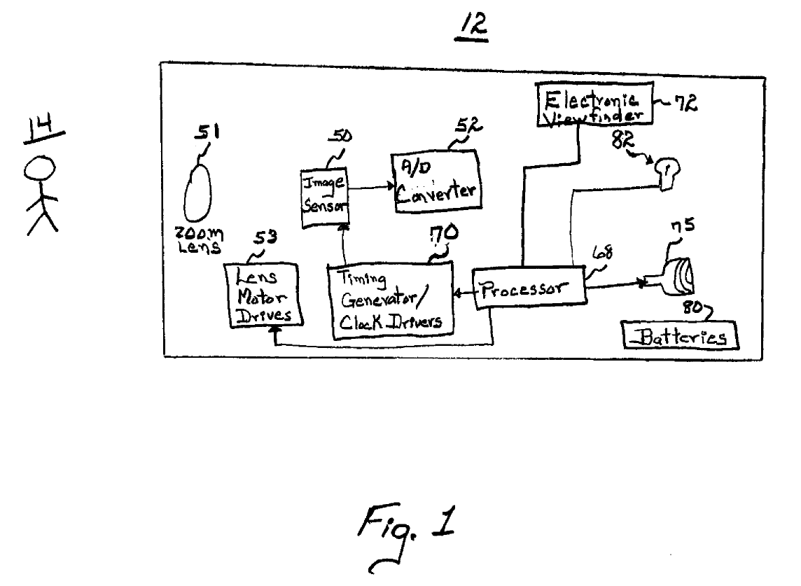

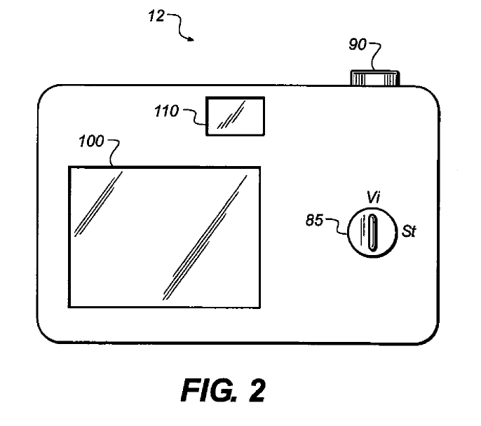

FIG. 1 illustrates a digital camera 12 that can capture either still or video images. The camera is powered by batteries 80, which supply power to the camera circuits depicted in FIG. 1. The digital camera 12 includes a zoom lens 51 having zoom and lens motor drives 53 and an adjustable aperture (not shown). The user composes the scene using the electronic viewfinder 72 and the zoom lens control buttons (not shown). The user decides whether a still or video image is desired and selects this mode on the user interface of FIG.2. When in still mode, the camera captures an image each time the capture button is pressed as described further below. When in video mode, the camera captures a sequence of images when the record button is pressed and keeps recording in video until the record button is pressed again.

To capture either a still image or video sequence, the zoom lens 51 focuses light from a subject 14 (see FIG. 1) on an image sensor 50, for example, a charge-coupled device image sensor or complementary metal oxide semiconductor (CMOS) image sensor using the well-known Bayer color filter pattern. The image sensor 50 is controlled by timing generator/clock drivers 70. The zoom and lens motors 53 and the clock drivers 70 are controlled by control signals supplied by a control processor 68. The analog output signal from the image sensor 50 is amplified and converted to digital data by the analog-to-digital (A/D) converter circuit 52. In still mode, this capture sequence is repeated each time the capture button (90 of FIG. 2) is pressed; and in video mode, the capture sequence is continuous until the record button 90 is pressed again to stop recording.

According to the present invention, upon startup, the processor 68 also functions to detect whether the user has selected video or still image mode (85 of FIG. 2). When in still image mode, the processor 68 directs a speaker 75 to output a first tone, and when in video mode, the processor 68 directs the camera to output a second tone. Alternatively, the processor may direct a light 82 to flash in a first frequency for still image mode, and a second frequency for video image mode. Although the present invention illustrates tones and lights as the sensory signal to the user, any sensory signal may be used such as different vibration frequencies or the like.

Startup is defined herein as when the camera is powered up when it has been in the off mode, or when it is powered up when it has been in the “sleep” mode. Sleep mode, as is well known in the art, is when the camera is powered down due to inactivity when in the on mode.

Referring to FIG. 2, there is shown the back side of the digital camera 12 having a plurality of user interfaces for permitting the user to operate the various functions of the camera. One user interface is a video/still mode selector 85 for permitting the user to rotate the selector 85 into the desired mode, either still or video. Another user interface is the record button 90 for permitting the user to record video images as described above when in video mode. The capture button 90 also permits capture of still images as described above when in still image mode. A display 100 permits the user to view the captured scene to be captured in real time. A viewfinder 110 may also be used to view the scene to be captured in real time.

The invention has been described in detail with particular reference to certain preferred embodiments thereof, but it will be understood that variations and modifications can be effected within the spirit and scope of the invention.

### PARTS LIST

12 digital camera
50 image sensor
51 zoom lens
52 A/D converter
53 lens motor drives
68 processor
70 timing generator/clock drivers
72 electronic viewfinder
75 speaker
80 batteries
82 light
85 mode selector
90 button
100 display
110 viewfinder

1. An imaging device having first and second operable modes of operation, the imaging device comprising:
(a) a user interface for selecting the first operable mode of operation or the second operable mode of operation;
(b) a processor that, upon startup, detects whether the first operable mode of operation or the second operable mode of operation is selected; and
(c) one or more sensory mechanisms that output a first signal when the processor detects the first operable mode and outputs a second signal when the processor detects the second operable mode of operation.

2. The imaging device as in claim 1, wherein the one or more sensory mechanisms are speakers.

3. The imaging device as in claim 1, wherein the one or more sensory mechanisms are light emitting devices.

4. The imaging device as in claim 2, wherein the speakers output a first tone as the first signal and a second tone as the second signal.

5. The imaging device as in claim 3, wherein the one or more light emitting devices emit light in a first frequency as the first signal and emit light in a second frequency as the second signal.
